(19) United States
(12) Patent Application Publication
(10) Pub. No.: US 2026/0016037 A1
(43) Pub. Date: Jan. 15, 2026

(54) PROVISION INTRODUCED IN A CONNECTOR FOR JOINING PROFILES APPLICABLE TO FURNITURE

(71) Applicant: Decio Carmona, Uberlandia (BR)

(72) Inventor: Decio Carmona, Uberlandia (BR)

(21) Appl. No.: 18/901,720

(22) Filed: Sep. 30, 2024

(30) Foreign Application Priority Data
Jul. 11, 2024 (BR) BR2020240143138

(51) Int. Cl. F16B 12/40

(52) U.S. Cl. CPC F16B 12/40

(57) ABSTRACT

The present disclosure combines the functions of joining profiles without the use of welding and in a fully editable way, thus providing a secure connection between profiles and optimized storage, logistics and installation by use of a junction connector, an extended junction connector, a locking ferrule, the structural body of the ferrule, a lateral positioner and a fixing screw; while this arrangement allows us to connect four profiles perpendicularly as the profiles to be joined have a hole at their ends for fixing the junction connector and the handle of the second profile, this connection is made according to the number of connections required via making lateral cuts in the face of the ends of the profile, receiving a locking ferrule, where the structural body of the ferrule will be inserted and fixed internally by the lateral positioner which receives a fixing screw.

### CROSS REFERENCE TO RELATED APPLICATION

This application is a Utility Application which claims the benefit of and takes priority from Brazilian Patent Application Serial No. BR 20 2024 014313 8 filed on Jul. 11, 2024, from which priority is claimed under all applicable sections of Title 35 of the United States Code including, but not limited to, Sections 120, 363, and 365(c).

### TECHNICAL FIELD

The present invention relates to a connector for use in furniture that requires profiles to be joined for assembly, with the aim of providing a quick and safe connection using a simple tool without special effort, as well as optimized storage, logistics and installation.

### BACKGROUND

Currently, the existing connectors, which combine the functions of joining profiles in a single element, are connectors for assembling various elements that do not require a more elaborate design template, they are connectors with aesthetic flaws that do not contribute to a perfect connection and fine adjustment, being unsuitable for furniture that requires a standard of finish, safety, easy and quick assembly, they do not achieve an ideal fit, making the connection visible.

It is well known that the correct use of connectors requires a correct installation operation, considering the weight to be distributed on the furniture, the structure coupled to the profile as well as the material. In the cases mentioned, there is the inconvenience of not having a tight, thin connection, where the joint is exposed and visible, and may even give way due to the type of adjustment made, in addition to the fact that aesthetically they do not meet the desirable standard for an impeccable finish.

### SUMMARY

The present invention was developed to solve these problems, whereby fine-tuning is covered by the process of assembling a set that results in a secure, fast and aesthetically precise connection, thus providing a high degree of efficiency in the connection between two profiles. This efficiency is achieved since the proposed arrangement has a junction connector that will join the profiles together. The junction connector will be locked by a ferrule that will receive a central structural body (core), with a hole in the bottom that, aligned with a hole in the side of the profile, will be inserted into a sequential connector with a circular finish and side rods to fit into the central structural body of the ferrule, where the fixing screw will be inserted, pressing the assembly against the inner side wall of the profile.

This assembly, which forms the connector, must be installed on the side desired for joining to another profile, or even on all four sides simultaneously, establishing a four-point connection, as well as a fifth connection, using the extension joint connector, which allows for a fifth connection at the top of the profile, approving eminent efficiency, both in terms of furniture safety and assembly time, resulting in better functionality for furniture finishing combinations.

### BRIEF DESCRIPTION OF THE DRAWINGS

The invention can be better understood through the following detailed description, in line with the attached figures, where:

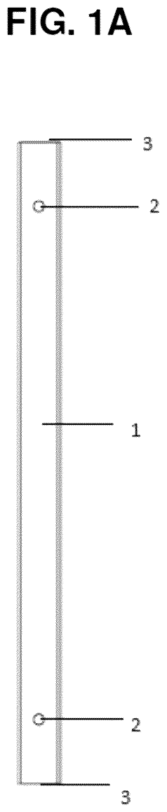

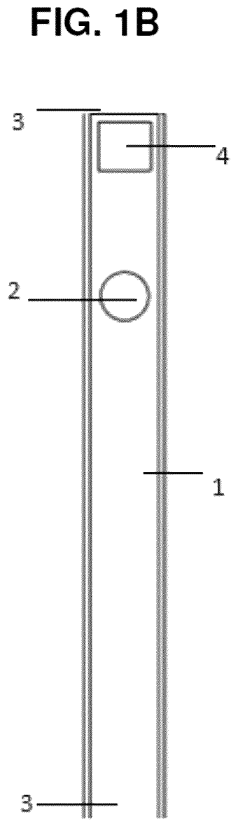

FIG. 1A shows a cutaway view of the profile for connecting the Junction Connector;
(1) profile body;
(2) hole for fixing the junction connector;
(3) top and bottom opening of the profile;

FIG. 1B shows a cross-section view of the profile for connecting the set of locking connectors;
(1) cut to fit the junction connector handle;
(2) hole for fixing the connector's locking screw;
(3) upper and lower profile opening;

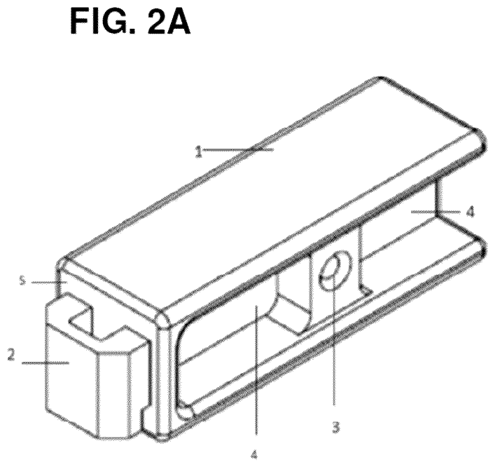

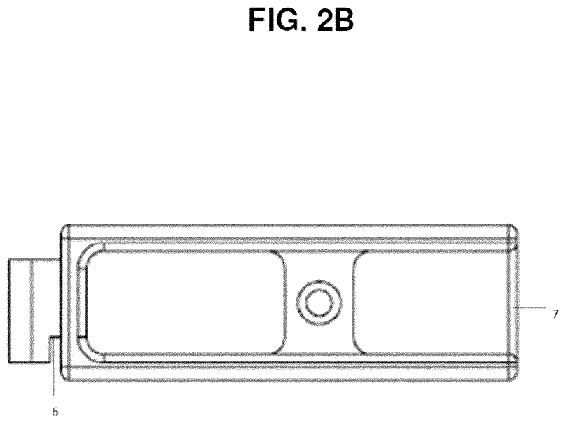

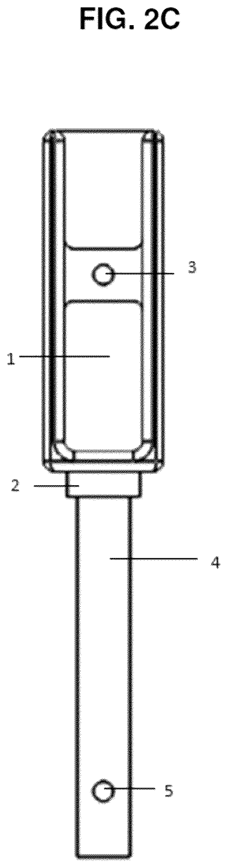

FIG. 2A shows an isometric view of the junction connector;
(1) junction connector body;
(2) joint connector handle;
(3) screw fixing hole;
(4) side wall of the junction connector;
(5) upper base of the junction connector with handle for connection;

FIG. 2B shows a side view of the junction connector;
(6) Cutting of the joining strap;
(7) Back of the connector without a handle;

FIG. 2C shows a front view of the extension joint connector;
(1) Extension joint connector body;
(2) flared finish to fit the ferrule;
(3) screw fixing hole;
(4) internal support body of the connector which receives the connector locking screw;
(5) screw fixing hole;

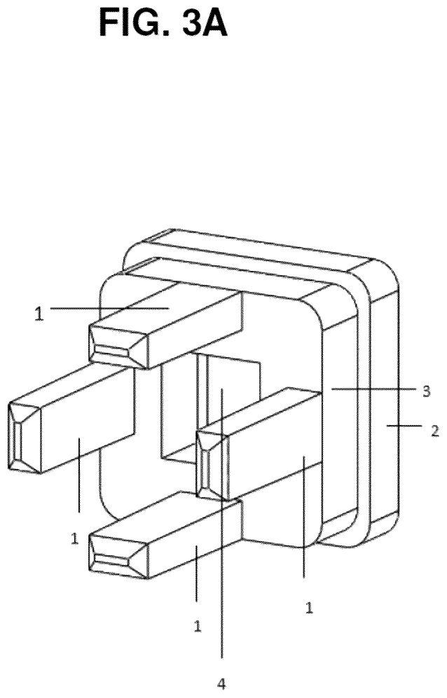

FIG. 3A shows an isometric view of the connector's locking ferrule;
(1) internal plug locks;
(2) connection head on the ferrule;
(3) fitting ledge in the profile;
(4) opening for the structural body of the connector locking ferrule to enter;

FIG. 3B shows a top view of the connector's locking ferrule;
(4) opening for entry of the structural body of the connector locking ferrule;

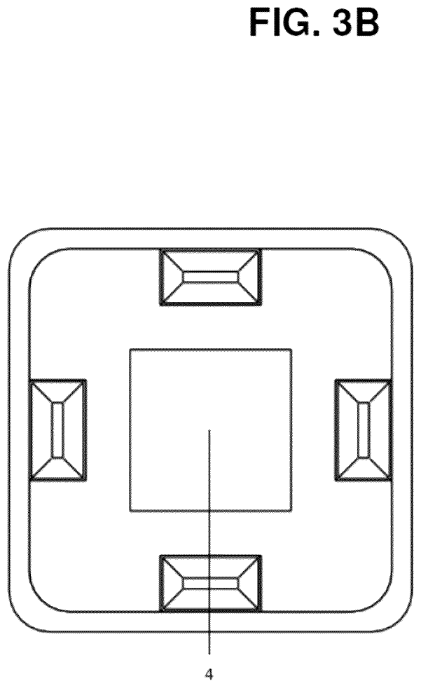

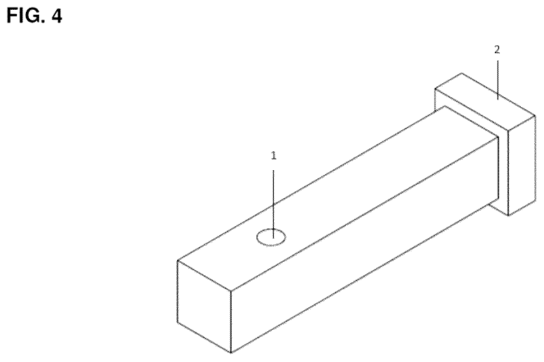

FIG. 4 represents an isometric view of the structural body of the connector's locking ferrule;
(1) hole for fitting the internal support bracket which receives the connector's locking screw;
(2) head of the structural body of the connector locking ferrule;

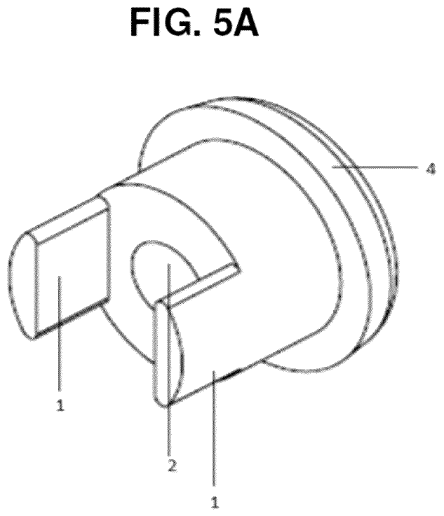

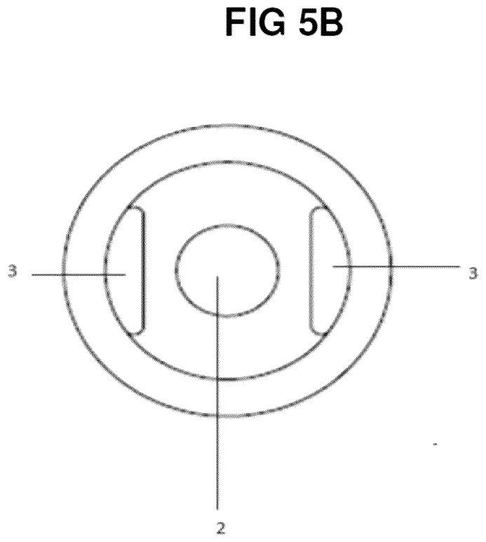

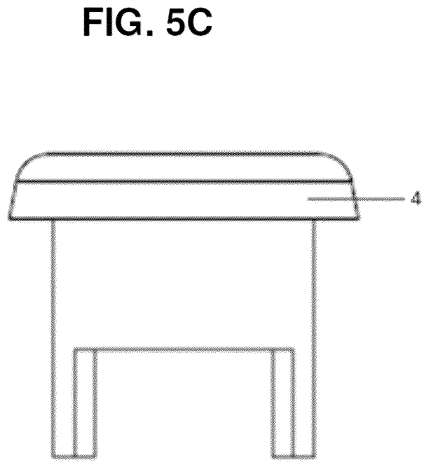

FIG. 5A shows an isometric view of the connector's internal support bracket;
(1) internal fitting rods in the structural body of the connector locking ferrule;

FIG. 5B shows a top view of the connector's internal support bracket;
(2) hole for inserting the locking screw for the connector's internal support bracket;

FIG. 5C shows a side view of the connector's internal support bracket;
(4) circular finish of the connector's internal support bracket for fitting into the profile hole;

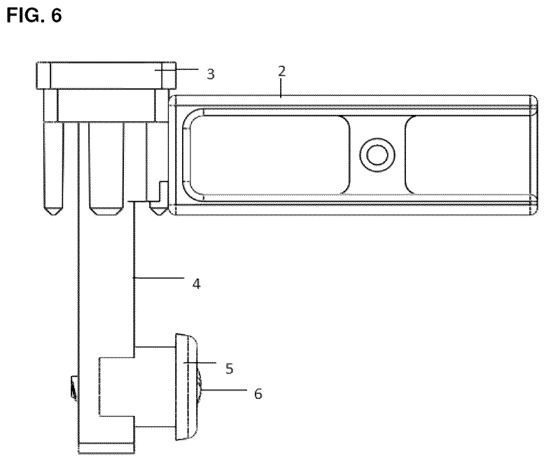

FIG. 6 shows a front view of the assembled connector;
(2) junction connector;
(3) connector locking ferrule;
(4) structural body of the connector locking ferrule;
(5) internal support bracket for the connector;
(6) connector locking screw;

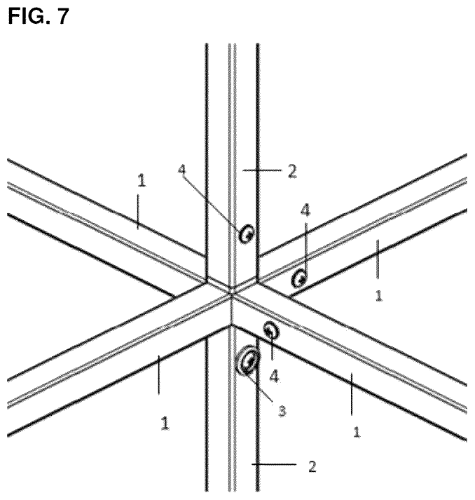

FIG. 7 shows an isometric view of the profiles assembled with joint connectors and extension joint connectors.
(1) perpendicular profiles using joint connectors;
(2) linear profiles using extension joint connectors;
(3) internal support bracket for the connector with screw;
(4) support screw for the joint connector.

### DETAILED DESCRIPTION OF THE EMBODIMENTS

With reference to these figures, you can see a joint connector (FIGS. 2A and 2B) that will connect the profiles (FIGS. 1A and 1B), making the union between them. The joint connector (FIGS. 2A and 2B) will be inserted from the side without the connecting handle (FIGS. 2A and 2B) into one of the openings in one of the profiles (FIGS. 1A and 1B) and secured with a screw by aligning a hole in both the connector and the profile (FIG. 2A number 3 and FIG. 1A number 2). The other profile to which the connection will be made must be fitted with cut-outs for this connection, on all four sides equally or only on the desired connection side/side (FIG. 1B number 4) at the top, and will receive the side of the joint connector with a handle (FIG. 2B number 3), where it will be locked by a ferrule with an opening (FIG. 3A) introduced at the top of the profile (FIG. 6 number 2), locking the connection to one, two, three or four profiles connected perpendicularly at angles of 90° (FIG. 7 number 1), this ferrule will receive a central structural body (core) (FIG. 4) to better structure the assembly by closing the ferrule. The structural body has a hole in the bottom (FIG. 4 number 1) which aligns with the hole in the lower side of the profile (FIG. 1B number 2), which will be filled with a sequential connector (FIGS. 5A, 5B and 5C) with a circular finish and side rods (FIG. 5A number 1) to fit into the central structural body of the ferrule (FIG. 6 number 3), where the fixing screw will be inserted (FIG. 6 number 6), pressing the assembly against the inner side wall of the profile, promoting total adjustment of the assembly. However, if there is a need for a fifth linear connection (FIG. 7 number 2) to increase the connection structure, instead of inserting the central structural body (core) (FIG. 4), the extended junction connector (FIG. 2C) should be inserted, which will play the role of both the core (FIG. 4) and a junction connector (FIG. 2A), receiving the sequential connector (FIG. 5A) for a better internal fit, and at the same time lengthening the assembly with a further connection (FIG. 7 number 2).

The junction connector (FIGS. 2A and 2B) is always placed between two profiles (FIGS. 1A and 1B), with one profile prepared with a hole (FIG. 1A number 2) for fixing the junction connector (FIGS. 2A and 2B) which is inserted into the inside of the profile (FIG. 1A), and the other profile with a cut in one or all of the sides at the top (FIG. 1B number 4) depending on the type of connection desired, to receive the handle of the junction connector (FIG. 2A number 2), and a hole in the lower part (FIG. 1B number 2) to receive a sequential connector with a screw to support the assembly (FIG. 6 number 5 and 6). The Extension Junction Connector can also be used to create a linear connection and be connected to more perpendicular connections.

The connector combines the functions of joining profiles without the use of welding and is fully editable, thus providing more options for connections between profiles for furniture with operational efficiency, as it does not require special tools for assembly, lower cost of the final product, as well as storage, logistics and optimized installation.

Installation of the connector is simple. Initially, the junction connector (FIG. 2A) must be inserted into a profile with fixing holes (FIG. 1A number 2) and the other end of the connector with handle (FIG. 2A number 2) into the profile with the appropriate cut-outs (FIG. 1A number 2 and 4), then the handle of the junction connector (FIG. 2A number 2), which we can call the “male” part, must be fitted to the side cut-out of the other profile (FIG. 1B number 4), which will be joined to what we can call the “female” part, pushing down the handle of the joint connector on the side that has a cut-out (FIG. 2B number 6), which will join the profiles (FIGS. 1A and 1B). Locking is carried out by inserting the connector's locking ferrule (FIG. 3A) into the upper part of the profile (FIG. 1A number 3), where one of its rods (FIG. 3A number 1) fits into the housing of the junction connector's handle (FIG. 2A).

To ensure the stability of the assembly, the structural body of the locking ferrule (FIG. 4) is inserted, which enters through the top opening of the connector's locking ferrule (FIG. 3B number 4), in order to press the ferrule (FIG. 3A) into the internal ends of the profile (FIG. 1B number 1), locking the internal system of the ferrule, which can be replaced by an extended joint connector if the fifth profile needs to be connected. To ensure that the structural body (FIG. 4) or the extended joint connector (FIG. 2C) is fixed and the assembly is properly finished (FIG. 4), the connector's internal support bracket (FIG. 6 number 5) should be placed, acting as a guide for the metal screw (FIG. 6 number 6) which is inserted in the center, so that the structural body (FIG. 4) or extended joint connector (FIG. 2C) does not move, guaranteeing the stability and support of the assembly (FIG. 6).

The system is joined by fitting the junction connector (FIG. 2A) into the cut-outs of two profiles (FIGS. 1A and 1B) which we can call male and female, with the ferrule (FIG. 3A) locking into the female profile (FIG. 1B). The stability of the system is guaranteed by inserting the structural body (FIG. 4) or the extended joint connector (FIG. 2C), pressing the ferrule (FIG. 3A) into the inner walls of the profile (FIG. 1B number 1). To ensure that the structural body (FIG. 4) does not move, the internal support bracket of the assembly (FIG. 5A) is inserted, which engages its rods (FIG. 5B number 1), fulfilling the role of both finishing and guide for the correct fitting of the screw.

What is claimed is:

1. A provision introduced in a connector for joining profiles applicable to furniture comprising:
a junction connector;
an extension joint connector;
a locking ferrule;
a structural body of the ferrule;
a lateral positioner; and
a fixing screw,
wherein the junction connector interconnects a plurality of perpendicular profiles fitted into each profile cut-out,
wherein the extended joint connector interconnects two linear profiles at an ends of the up to four perpendicular profiles,
wherein the locking ferrule opens at a top and receives the structural body of the ferrule or the extension joint connector,
wherein the locking ferrule is supported by the lateral positioner, receives a bolt, and supports an assembly.

2. The provision introduced in a connector for joining profiles applicable to furniture according to claim 1, further comprising allowing the plurality of perpendicular profiles to be joined perpendicularly to a main profile.

3. The provision introduced in a connector for joining profiles applicable to furniture according to claim 1, further comprising a linear joint with holes and cut-outs predefined to receive the assembly.

4. The provision introduced in a connector for joining profiles applicable to furniture according to claim 1, further comprising the structural body of the ferrule supporting the plurality of perpendicular profiles.

5. The provision introduced in a connector for joining profiles applicable to furniture according to claim 1, further comprising the extension joint connector supporting and connecting the two linear profiles.
